(19) United States
(12) Patent Application Publication
(10) Pub. No.: US 2003/0079103 A1
(43) Pub. Date: Apr. 24, 2003

(54) Apparatus and method to perform address translation

(76) Inventor: Michael W. Morrow, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/027,978

(22) Filed: Oct. 24, 2001

(51) Int. Cl. G06F 12/10; G06F 12/14

(52) U.S. Cl. 711/206; 711/163

(57) ABSTRACT

Briefly, in accordance with one embodiment of the invention, a bus controller is adapted to provide virtual-to-physical address translation and memory access protection functions.

### BACKGROUND

Microprocessor systems that include virtual addressing may include a memory management unit (MMU) to provide virtual-to-physical address translation. In addition, an MMU may provide protection functions for accessing information in memory. For example, certain portions of the memory may be specified as protected from certain accesses.

One problem that may arise from the use of an MMU, is that the addition of an MMU may increase the overhead and adversely affect the performance of the system. For example, the address translations and memory protection operations performed by MMUs may be time consuming relative to other operations of the system.

Thus, there is a continuing need for better ways to perform address translation and memory protection in electronic systems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a computing device in accordance with an embodiment of the present invention; and

FIG. 2 is a diagram illustrating a table walk operation in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

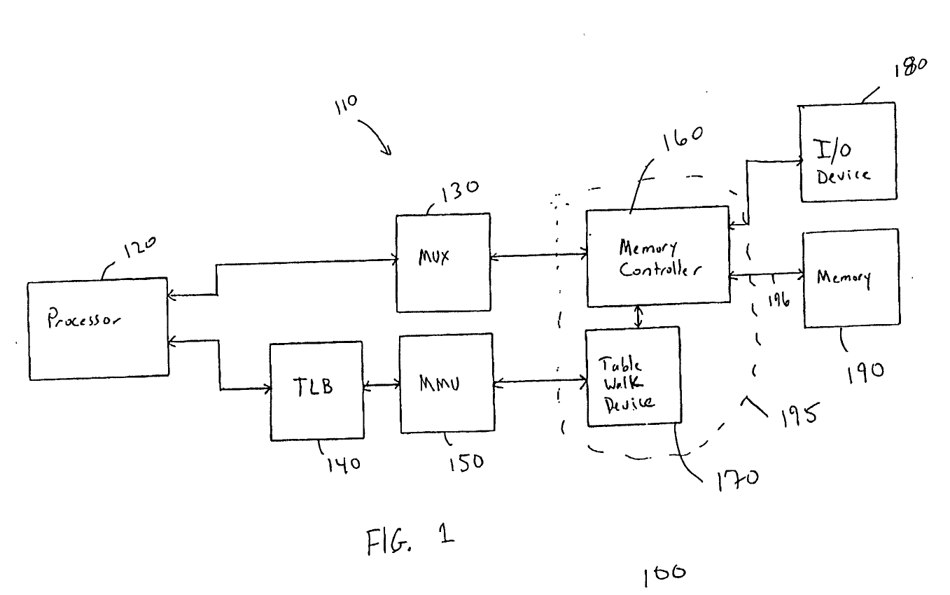

Turning to FIG. 1, an embodiment 100 in accordance with the present invention is described. Embodiment 100 may comprise a computing system 110. Computing system 110 may be used in a variety of portable communication systems such as, for example, a mobile communication device (e.g., a cell phone), a two-way radio communication system, a one-way pager, a two-way pager, a personal communication system (PCS), a portable computer, a personal digital assistant (PDA), or the like. Although it should be pointed out that the scope and application of the present invention is in no way limited to these examples. For example, other applications where the present invention may be used are non-portable electronic applications, such as in cellular base stations, servers, desktop computers, video equipment, etc.

In this example, computing system 110 may include a processor 120, a multiplexer (MUX) 130 connected to processor 120, translation lookaside buffer (TLB) 140 connected to the processor 120, and a memory management unit (MMU) 150. In addition, computing system 110 may include a memory controller 160 connected to MUX 130, a table walk device 170 connected to memory controller 160, an input/output (I/O) device 180 connected to memory controller 160, and a memory device 190 connected to memory controller 160. Further, embodiment 100 may comprise a bus controller 195, wherein bus controller 195 includes memory controller 160 and table walk device 170. It should be noted that only a portion of computer system 110 is illustrated in FIG. 1 and that the scope of the present invention is not limited to this example. Computer system 110 may be coupled to other circuits or components (not shown) such as, for example, another processor, a clock, etc., as part of a larger system.

Processor 120 may be adapted to execute a software process that includes software instructions. Processor 120 may comprise, for example, a microprocessor, a digital signal processor, a microcontroller, or the like.

Instructions to be executed by processor 120 may be stored in memory 190. Memory 190 may be volatile or non-volatile memory, although the scope of the present invention is not limited in this respect. Memory 190 may comprise, for example, a disk including floppy disks, optical disks, CD-ROMs, magnetic-optical disks, read-only memories (ROMs), random access memories (RAMs) such as dynamic RAM (DRAM) or static RAM (SRAM), electrically programmable read-only memories (EPROMs), electrically erasable and programmable read only memories (EEPROMs), magnetic or optical cards, or any other type of media suitable for storing electronic instructions. In addition, memory 190 may be a cache memory that is a relatively smaller and faster type of memory compared to, for example, a hard disk memory. Further, memory 190 may be integrated (“on-chip”) with processor 120 or discrete/external (“off-chip”) from processor 120.

I/O device 180 may be used for receiving data from a user or may be used for transmitting data to a user. I/O device 180 may comprise, for example, a keyboard, a display, or a printer, although the scope of the present invention is not limited in this respect.

Bus controller 195 may be adapted to control the transfer of information within computing device 110. For example, bus controller 195 may serve as an interface between processor 120 and memory 190 and as an interface between processor 120 and I/O device 180. Bus controller 195 may provide timing, command, or control signals to memory 190 and I/O device 180. Examples of control signals provided by bus controller 195 may include read and write signals. A write signal may indicate that a write bus cycle is in progress, e.g., the write signal may indicate that data to be written to memory 190 is present on a data bus 196. On the other hand, a read signal may indicate that a read bus cycle is in progress, e.g., the read signal may indicate that data to be read from memory 190 is present on data bus 196. In an alternate embodiment, bus controller 195 may also provide bus arbitration by generating control signals such as, for example, a bus busy signal. This may be done in systems employing multiple processors sharing the same bus.

Memory controller 160 may be adapted to control memory 190. For example, memory controller 160 may provide read and write signals. Further, if memory 190 is a volatile memory device, such as, for example, a dynamic random access memory (DRAM) device, memory 190 may control refreshing of memory 190 to retain stored data or instructions. In an alternate embodiment, if memory 190 is a flash memory device, memory controller 190 may control programming or erasing of memory 190.

Bus controller 195 may be controlled by processor 120 through MUX 130. MUX 130 may include circuitry adapted to select one of several inputs on the basis of an address or status code. The data at the selected input may then be routed to an output. For simplicity, MUX 130 is shown as having a single input terminal and output terminal, although the scope of the present invention is not limited in this respect.

Generally, table walk device 170 may be adapted to perform a table walk operation that may include retrieving information from translation tables stored in memory 190. Entries in the translation tables may be used by table walk device 170 to perform virtual-to-physical address translations and memory access protection operations.

In an alternate embodiment, table walk device 170 may provide memory access protection by determining whether a process executing in processor 120 is permitted to access data stored in memory 190. This may be accomplished by retrieving memory access permission information from the translation tables stored in memory 190. If table walk device 170 determines that the process executing in processor 120 is not permitted to access data stored in memory 190, then bus controller 195 may transmit a memory abort signal to processor 120.

TLB 140 may be a caching device for storing results of table walk operations. Thus, a software process executing in processor 120 using virtual addressing may first transmit a virtual address to TLB 140. The physical address may be determined by TLB 140 using the result of a recent table walk operation. However, if the physical address can not be determined using TLB 140, then the virtual address may be transmitted to table walk device 170. A table walk may be performed by table walk device 170 to determine the corresponding physical address. As discussed above, a table walk operation may include retrieving information from translation tables stored in memory 190. During a table walk, the information in the translation tables may be used to perform virtual-to-physical address translations and memory access protection operations.

MMU 150 may be adapted to perform part or all of the memory access protection operation. For example, after a table walk is performed by table walk device 170, the information derived from the table walk may be transmitted to MMU 150. MMU 150 may evaluate the information to determine whether a process executing in processor 120 is permitted to access data stored in memory 190. If MMU 150 determines that the process is not permitted to access data stored in memory 190, then MMU 150 may transmit an abort signal to processor 120 to prevent the process from accessing data in memory 190.

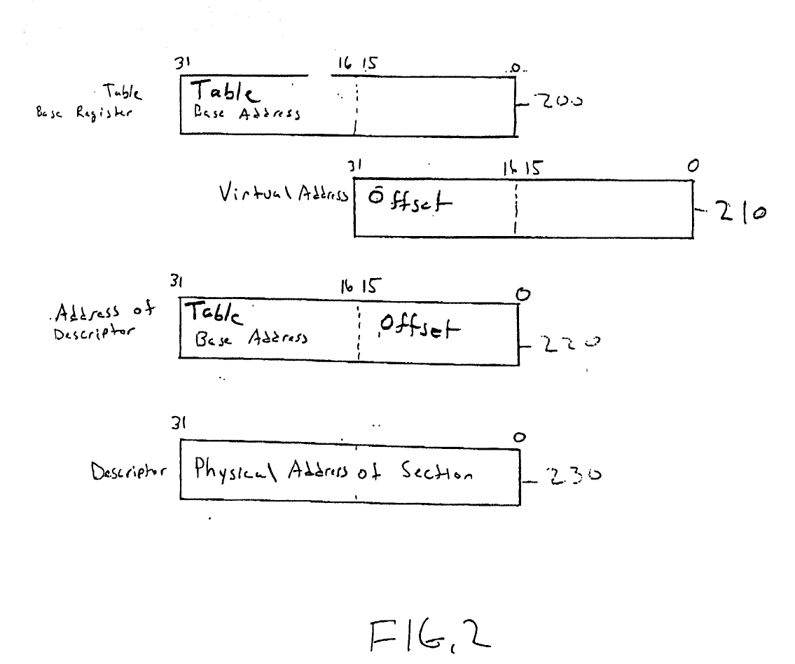

Turning to FIG. 2, an example of a table walk operation is illustrated in accordance with an embodiment of the present invention. Table walk device 170 (FIG. 1) may include circuitry such as, for example, combinational logic to perform the table walk operation. Box 200 illustrates a table base address. By way of example, the table base address 200 may be a 32-bit address which contains the base location of the translation tables stored in memory 190. The base address may be stored in a translation table base register. Bus controller 195 (FIG. 1) or, more particularly, table walk device 170 may include a table base register to store the table base address. Box 210 illustrates a virtual address. The virtual address may comprise 32-bits, of which bits [31:16] may contain an offset. The offset may be an index or offset in memory from the base address. Table walk device 170 may be adapted to receive the virtual address.

During a table walk, table walk device 170 may be adapted to combine or concatenate the table base address and the offset to generate an address of a descriptor (box 220) in memory 190. The descriptor may contain information about the physical address. For example, the descriptor may be the physical address (box 230), in which case, the translation is complete. Or alternatively, the descriptor may be a pointer to the physical address, i.e., the descriptor may be an address to the block of data in memory 190 containing the physical address. After the physical address is determined, it may be stored in TLB 140 for processing.

In an alternate embodiment, the descriptor or the physical address may contain memory access permission information. For example, bits [1:0] of the descriptor may contain access permission information. Table walk device 170 may evaluate the access permission information and perform a memory access protection operation to determine if the process executing in processor 120 may access data stored in memory 190.

Although not shown, computer system 110 may include a clock adapted to regulate the rate at which instructions are executed. In an alternate embodiment, computer system 110 may include two clocks (not shown) so that, for example, processor 120, MUX 130, TLB 140, and MMU 150 may operate at a first clock rate and memory controller 160, I/O device 180, memory 190, and bus controller 195 may operate at a second clock rate. As an example, processor 120 may operate at a clock speed of approximately 500 megahertz (MHz) and bus controller 195 may operate at a clock speed of approximately 100 MHz.

Referring back to FIG. 1, in one embodiment, memory controller 160 may be adapted to perform a virtual-to-physical address translation by, for example, integrating table walk device 170 with memory controller 160. In an alternate embodiment, bus controller 195, including memory controller 160 and table walk device 170, may be integrated with processor 120. In another embodiment, portions of the functionality of bus controller 195 may be implemented in processor 120 as, for example, a software application, module, or routine. In yet another embodiment, bus controller 195 may be implemented as part of memory 190 (e.g., as a separate function within a memory module). In yet another embodiment, bus controller 195 may be a discrete bus controller, wherein bus controller 195 is external (“off-chip”) to processor 120. Hybrid implementations are also possible. As will be appreciated, many alternative configurations are possible.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

[image]

1. An apparatus, comprising a bus controller adapted to provide virtual-to-physical address translation.

2. The apparatus of claim 1, wherein the bus controller comprises a table walk device to provide the virtual-to-physical address translation by performing a table walk to generate a physical address.

3. The apparatus of claim 2, further comprising a translation lookaside buffer (TLB) coupled to the bus controller to receive the physical address.

4. The apparatus of claim 1, wherein the bus controller comprises a table base register adapted to store a table base address.

5. The apparatus of claim 1, wherein the bus controller generates a read signal and a write signal, wherein the read sign al indicates a read bus cycle is in progress and the write signal indicates that a write bus cycle is in progress.

6. The apparatus of claim 1, further comprising:
a memory device coupled to the bus controller; and
a processor coupled to the bus controller.

7. The apparatus of claim 6, wherein the bus controller is adapted to provide memory access protection.

8. The apparatus of claim 7, wherein the bus controller provides memory access protection by determining whether a process executing in the processor is permitted to access data stored in the memory device.

9. The apparatus of claim 8, wherein the bus controller transmits an abort signal to the processor when the process executing in the processor is not permitted to access data stored in the memory.

10. The apparatus of claim 6, wherein the processor operates at a first clock rate and the bus controller operates at a second clock rate, wherein the first clock rate is greater than the second clock rate.

11. The apparatus of claim 6, wherein the bus controller is adapted to provide control signals to the memory device.

12. The apparatus of claim 6, wherein the memory device is a nonvolatile memory device and the bus controller controls programming of the memory device.

13. The apparatus of claim 6, wherein the memory device is a volatile memory device and the bus controller controls refreshing of the memory device.

14. An apparatus, comprising:
a memory controller; and
a table walk device connected to the memory controller.

15. The apparatus of claim 14, wherein the table walk device combines a portion of a virtual address and a portion of a base address.

16. The apparatus of claim 14, wherein the table walk device comprises a table base register to store a table base address.

17. The apparatus of claim 14, further comprising a translation lookaside buffer (TLB) coupled to the table walk device.

18. The apparatus of claim 17, wherein the table walk device generates a descriptor and the TLB is adapted to receive the descriptor from the table walk device.

19. The apparatus of claim 14, wherein the table walk device is adapted to receive memory access protection data.

20. The apparatus of claim 14, wherein the apparatus further comprises:
a processor coupled to the table walk device; and
a memory device coupled to the memory controller.

21. The apparatus of claim 20, wherein the table walk device is adapted to determine whether a process executing in the processor is permitted to access data stored in the memory device.

22. The apparatus of claim 21, wherein the table walk device transmits an abort signal to the processor if the process is not permitted to access data stored in the memory device.

23. A system, comprising:
a processor;
a discrete memory controller adapted to perform a table walk operation and coupled to the processor; and
a volatile memory device coupled to the discrete memory controller.

24. The system of claim 23, further comprising a memory management unit (MMU), wherein the discrete memory controller is coupled to the processor via the MMU.

25. The system of claim 24, wherein the MMU is adapted to provide memory access protection by preventing a process executing in the processor from accessing predetermined data in the volatile memory device.

26. The system of claim 23, wherein the discrete memory controller is adapted to provide address translation by using results of the table walk.

27. The system of claim 23, wherein the discrete memory controller performs a table walk by combining a portion of a virtual address and a portion of a base address to generate an address of a descriptor.

28. The system of claim 23, wherein the volatile memory device is a dynamic random access memory (DRAM) device.

29. A method, comprising:
executing instructions at a first clock rate; and
performing a table walk operation at a second clock rate.

30. The method of claim 29, wherein the first clock rate is greater than the second clock rate.

31. The method of claim 29, further comprising determining memory access permission at the second clock rate.

32. The method of claim 29, wherein performing the table walk operation comprises concatenating a portion of a virtual address and a portion of a base address.

33. The method of claim 29, wherein performing the table walk operation comprises generating a descriptor.
